(19) United States
(12) Patent Application Publication
(10) Pub. No.: US 2021/0172623 A1
(43) Pub. Date: Jun. 10, 2021

(54) INTELLIGENT DEHUMIDIFIER WITH DUAL COIL ENERGY EXCHANGER FOR HORITCULTURE ENVIRONMENT

(71) Applicant: Inspire Holdings LLC, San Francisco, CA (US)

(72) Inventors: Roberto Battiston, Kensignton, CA (US); Bryan Hesterman, Oakland, CA (US); Adrian Giovenco, Kinsington, CA (US)

(73) Assignee: Inspire Holdings LLC, San Francisco, CA (US)

(21) Appl. No.: 16/709,756

(22) Filed: Dec. 10, 2019

(51) Int. Cl. F24F 3/153; A01G 9/24; F24F 3/147; F24F 3/14

(52) U.S. Cl. CPC F24F 3/153; F24F 2003/1452; F24F 3/147; A01G 9/246

(57) ABSTRACT

An intelligent dehumidification system that is energy efficient and automatically maintains environment parameters within a horticulture environment. The intelligent dehumidifier utilizes a dual coil energy exchanger to efficiently transfer energy before and after a dehumidification mechanism within the dehumidifier system. The dehumidified air is then released out to the environment. The dehumidification of the air is energy efficient by recycling water to drop the temperature of incoming air before being dehumidified, thereby reducing the energy required dehumidify the air by the dehumidifier. The dehumidification system is further energy efficient because warmed water is used to re-heat the dehumidified air before it is provided back to the environment, thereby reducing the energy required to get the air back to room temperature.

### BACKGROUND

Growing plants can be difficult task and requires significant expertise and attention. Some plants require a very specific environment in order to thrive. Prior systems for creating an appropriate environment require a large amount of energy as well as significant time and manual effort to ensure the conditions in the environment are satisfactory. What is needed is an improved system for monitoring and controlling a plant growing and processing environment.

### SUMMARY

The present system, roughly described, provides an intelligent environment control system that provides energy efficient dehumidification and automatically controls and maintains environment parameters within a horticulture environment. The intelligent dehumidifier utilizes a dual coil energy exchanger to efficiently transfer energy before and after a dehumidification mechanism within the dehumidifier system. In some instances, the dehumidification system includes a first coil placed before a dehumidification coil and a second coil placed after a dehumidification coil. The first coil, or upstream coil, receives environment air and cools the air using cool liquid, such as for example water. The water is heated by the cooling process and is pumped to a second energy exchange coil. The air, already cooled, is dehumidified by the dehumidifier coil, bringing the air to and below its dew point in order to remove water from the air. The air is then pushed through the second energy exchange coil, having the warmed liquid, and the air temperature is raised. The warm liquid is cooled, and pumped back to the first coil as cooled liquid. The warmed and dehumidified air is then released out to the environment. The dehumidification of the air is energy efficient by recycling liquid to drop the temperature of incoming air before being dehumidified, thereby reducing the energy required dehumidify the air by the dehumidifier. The dehumidification system is further energy efficient because warmed liquid is used to re-heat the dehumidified air before it is provided back to the environment, thereby reducing the energy required to get the air back to the temperature required to maintain the room at a specific temperature.

The dehumidification system is intelligent in that automatically controls and maintains several environmental factors. The dehumidification system can be programmed with thresholds at which to maintain humidity levels, temperature, and CO₂ levels. In some instances, the thresholds may be maintained as a range, such as a particular value plus or minus two percent. The dehumidification system can also be programmed with a schedule to apply certain environmental conditions. For example, the dehumidification system can implement a lighting schedule for plants within the horticulture environment and a watering schedule for plants within the horticulture environment. The schedules can be implemented for different life cycles of the plant. For example, a watering schedule may differ for particular plant seedling, growing, and flowering stage.

In addition to implementing a schedule statically, according to a set period of times, the dehumidification system can implement a schedule dynamically based on a feedback system. For example, a horticulture environment may include sensors throughout the environment, including in the path airflow within the environment. Sensors may be placed along the path of air flow upstream, downstream, and within an area having plants, near the input and output of a dehumidification system within the horticulture environment, and in other areas of the environment. The group of sensors may include different types of sensors, including but not limited to light sensors, CO₂ level sensors, temperature sensors, and humidify level sensors. In some instances, the humidify level sensors may detect the water consumed by the plants by measuring an increase in the air flow humidity at the input and output of the dehumidification system. Based on the difference in humidity, a plant watering can be initiated for the amount of water that the plants are releasing, detected as a change in humidity.

In some instances, a system controller can communicate with the dehumidification system to control the dehumidification based on data received from the one or more sensors, and may communicate with one or more other controllers to control and manage the horticulture environment temperature, CO₂, and lighting. The system controller can also communicate with a remote server application to receive control data for managing the horticulture environment, report environmental data retrieved from the sensors within the environment, and perform other functions.

In some instances, a system for automatically dehumidifying a horticulture environment includes a dehumidifier, a plurality of sensors, and a system controller, and optionally a temperature controlling device such as a package air conditioning system. The dehumidifier dehumidifies air that flows from a dehumidifier input towards a dehumidifier output within the dehumidifier, wherein the air flow traveling through plants within a horticulture environment while outside the dehumidifier. The dehumidifier includes a dehumidification mechanism, a first energy exchange coil, and a second energy exchange coil. The first energy exchange coil is positioned upstream in the air flow within the dehumidifier. The second energy exchange coil is positioned downstream in the air flow within the dehumidifier, wherein an energy exchanging liquid moves from the second energy exchange coil to the first energy exchange coil along a first path, and the energy exchange liquid moving from the first energy exchange coil to the second energy exchange liquid along a second path. The energy exchange liquid being warmed when traveling through the first energy exchange coil and traveling to the second energy exchange coil as a cool energy exchange liquid. The energy exchange liquid being cooled when traveling through the second energy exchange coil and traveling to the first energy exchange coil as a warm energy exchange liquid. The plurality of sensors detects humidity in a plurality of positions within the horticulture environment and outside the dehumidifier. The system controller receives data from the plurality of sensors and sends control signals to the dehumidifier based on the data received from the plurality of sensors. The dehumidifier performs dehumidification of the horticulture environment air in response to control signals received from the system controller.

In embodiments, a method is disclosed for automatically dehumidifying a horticulture environment. The method includes receiving air from a horticulture environment by a dehumidifier and displacing the received air through a first energy exchange coil. The first energy exchange coil receives energy exchange liquid that is colder than the received air, the temperature of the air being lowered as a result of being passed through the first energy exchange coil. The temperature of the energy exchange liquid is increased as a result of passing warm air through the first energy exchange coil.

The method further includes dehumidifying the cooled air by a dehumidifier, displacing the warmed energy exchange liquid to a second energy exchange coil, and displacing the dehumidified air through a second energy exchange coil. The second energy exchange coil receives the energy exchange liquid from the first energy exchange coil. The energy exchange liquid received by the second energy exchange coil is warmer than the dehumidified air. The temperature of the air is increased as a result of being passed through the second energy exchange coil and the temperature of the energy exchange liquid is decreased as a result of passing the dehumidified air through the second energy exchange coil. The dehumidified air is provided into the horticulture environment after the air is displaced through the second energy exchange coil.

The method also includes receiving data from a plurality of sensors and repeating the steps of receiving air, displacing the received air through a first energy exchange coil, dehumidifying the cooled air, displacing the dehumidified air through a second energy exchange coil, and outputting the dehumidified air in response to the data received from the plurality of sensors.

### BRIEF DESCRIPTION OF FIGURES

FIG. 1A is a block diagram of an intelligent dehumidifier in a horticulture environment.

FIG. 1B is a block diagram of another intelligent dehumidifier in a horticulture environment.

FIG. 2 is a block diagram of a dehumidifier with a dual coil energy exchanger.

FIG. 3 is a block diagram of a control architecture for an intelligent dehumidifier.

FIG. 4 is a block diagram of a system controller.

FIG. 5 is an exemplary method for operating an intelligent dehumidifier.

FIG. 6 is an exemplary method for automatically dehumidifying air in a horticulture environment.

FIG. 7 is an exemplary method for automatically replenishing water in a horticulture environment.

FIG. 8 is an exemplary method for performing environment control operations in a horticulture environment.

FIG. 9 is a block diagram of a computing environment for implementing the present technology.

### DETAILED DESCRIPTION

The present system, roughly described, provides an intelligent humidification system that is energy efficient and automatically maintains environment parameters within a horticulture environment. The intelligent humidifier utilizes a dual coil energy exchanger to efficiently transfer energy before and after a dehumidification mechanism within the dehumidifier system. In some instances, the dehumidification system includes a first coil place before a dehumidification coil and a second coil placed after a dehumidification coil. The first coil, or upstream coil, receives environment air and cools the air using cool liquid. The water is heated by the cooling process and is pumped to a second energy exchange coil. The air, already cooled, is dehumidified by the dehumidifier coil, bringing the air to below dew point in order to remove water from the air. The air is then pushed through the second energy exchange coil, having the warmed water, and the air temperature is raised. The warm water is cooled, and pumped back to the first coil as cooled water. The warmed and dehumidified air is then released out to the environment. The dehumidification of the air is energy efficient by recycling water to drop the temperature of incoming air before being dehumidified, thereby reducing the energy required to dehumidify the air by the dehumidifier. The dehumidification system is further energy efficient because warmed water is used to re-heat the dehumidified air before it is provided back to the environment, thereby reducing the energy required to get the air back to room temperature.

The dehumidification system is intelligent in that automatically controls and maintains several environmental factors. The dehumidification system can be programmed with thresholds at which to maintain humidify levels, temperature, and CO₂ levels. In some instances, the thresholds may be maintained as a range, such as a particular value plus or minus two percent. The dehumidification system can also be programmed with a schedule to apply certain environmental conditions. For example, the dehumidification system can implement a lighting schedule for plants within the horticulture environment and a watering schedule for plants within the horticulture environment. The schedules can be implemented for different life cycles of the plant. For example, a watering schedule may differ for a particular plant seedling, growing, and flowering stage.

In addition to implementing a schedule statically, according to a set period of times, the dehumidification system can implement a schedule of temperatures, humidity, watering, CO₂ level, lighting, and so forth dynamically based on a feedback system. For example, a horticulture environment may include sensors throughout the environment, including in the path airflow within the environment. Sensors may be placed along the path of air flow upstream, downstream, and within an area having plants, near the input and output of a dehumidification system within the horticulture environment, and in other areas of the environment. The group of sensors may include different types of sensors, including but not limited to light sensors, CO₂ level sensors, temperature sensors, and humidify level sensors. In some instances, the humidity level sensors may detect the water consumed or released by (as in drying) or transpired by the plants by measuring an increase in the air flow humidity at the input and output of the dehumidification system. Based on the difference in humidity, a plant watering can be initiated for the amount of water that the plants are releasing, detected as a change in humidity.

In other instances, this measurement may be done through a weighing of the plant at different times of the day and before and after watering of the plants as when they are in the growing process, or throughout the drying process to monitor product quality. In some instances, a system controller can communicate with the dehumidification system to control the dehumidification based on data received from the one or more sensors, and may communicate with one or more other controllers to control and manage the horticulture environment temperature, CO₂, and lighting. The system controller can also communicate with a remote server application to receive control data for managing the horticulture environment, report environmental data retrieved from the sensors within the environment, and perform other functions.

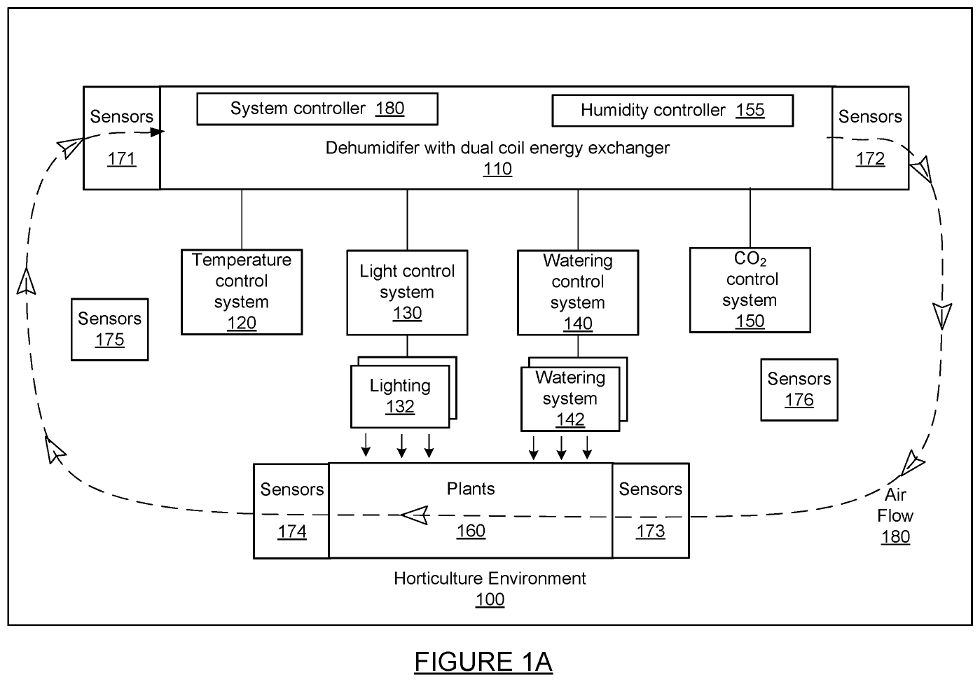

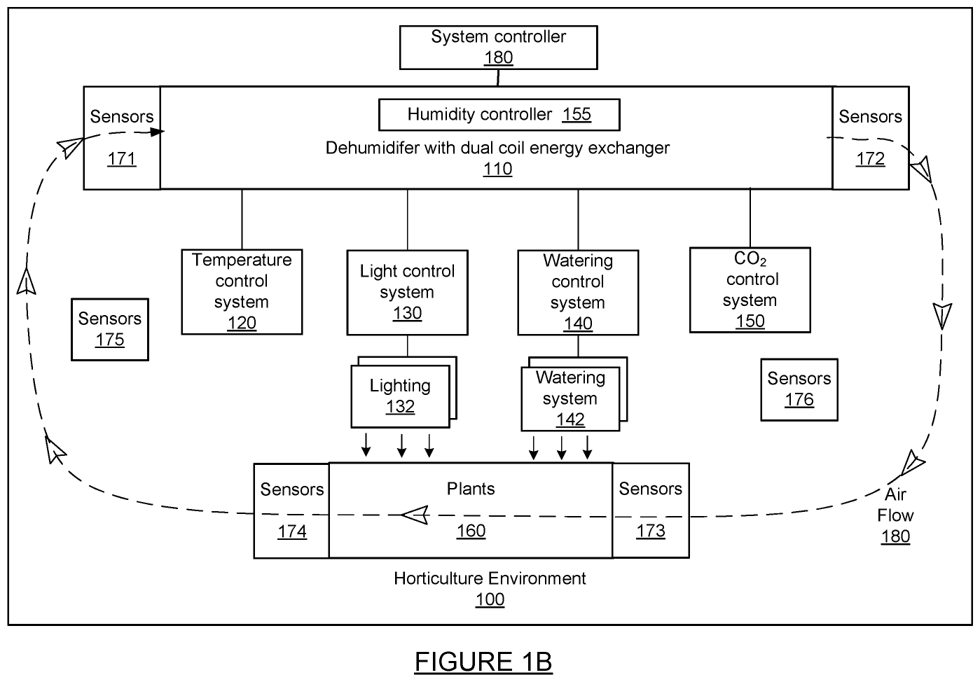

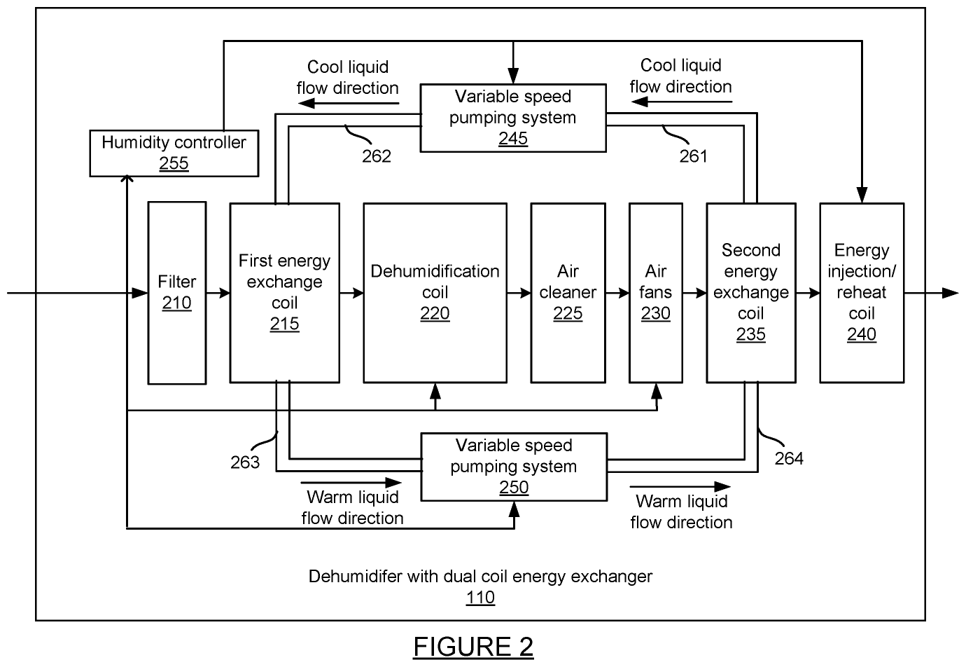

FIG. 1A is a block diagram of an intelligent dehumidifier in a horticulture environment. The horticulture environment 100 of FIG. 1A includes dehumidifier 110, temperature control system 120, light control system 130, watering control system 140, carbon dioxide (CO₂) control system 150, humidity controller 155, plants 160, and sensors 171-176. The dehumidifier 110 may dehumidify horticulture environment air as it flows along air flow path 180 throughout the horticulture environment 100, including through plants 160. The dehumidifier may include a dual coil energy exchanger that operates in front of and after a dehumidification mechanism. A dehumidifier with a dual coil energy exchanger is discussed in more detail with respect to FIG. 2.

The dehumidifier 110 may include system controller 180. The system controller 180 may, in some instances, be implemented within dehumidifier 110. System controller 180 may communicate with temperature control system 120, light control system 130, watering control system 140, and CO₂ control system 150 in the environment of FIG. 1A. The system controller may generate and send control signals (e.g., commands) to each of controllers 120-150 to control an aspect of the horticulture environment 100, including the care and development of plants 160. For example, system controller may send a temperature command to temperature control system 120 to maintain the temperature within horticulture environment 100 at ninety degrees Fahrenheit. Similarly, the system controller 180 may provide one or more commands to light control system 130 to implement a schedule of lighting for plants 160. (e.g., a first level of lighting between 8:00 AM to 5:00 PM, a second level of lighting between 5:00 PM to 8:00 pm and 5:00 AM to 8:00 AM, and a third level of lighting between 8:00 PM to 5:00 AM. The period and duration of the duty cycle can be determined, for example by the grower, to be any value.

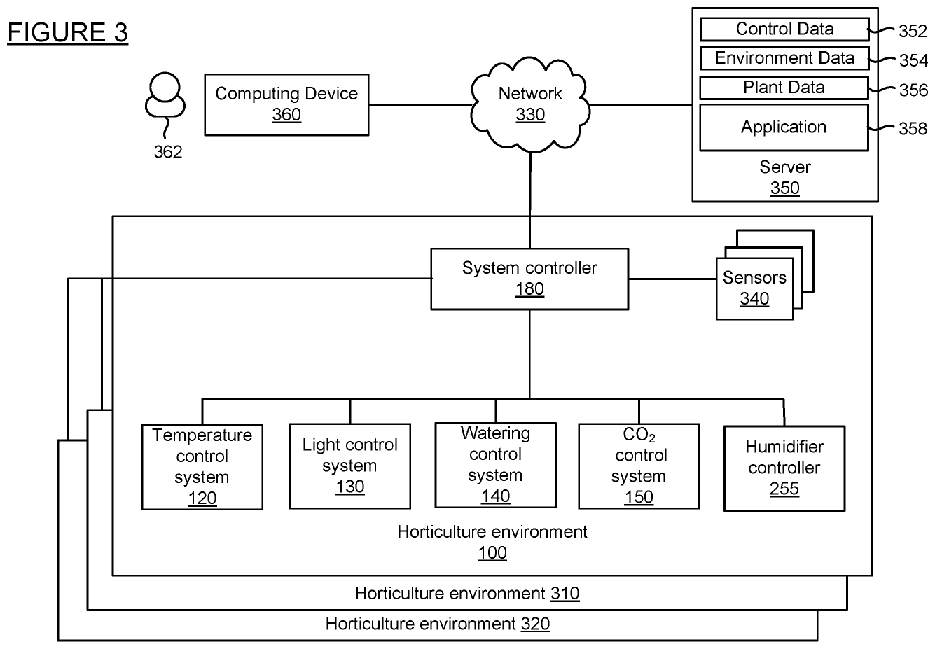

System controller 180 may be programmed with data locally via an input/output interface. The input/output interface may allow a user to provide control data and schedule data for controlling the horticulture environment. The input/output interface may also be used to specify reporting information, networking information, account information, identify different horticulture environments and their respective control data for management by the system controller, and other configurations. System controller 180 is discussed in more detail with respect to FIG. 3.

Temperature control system 120 may detect a temperature of horticulture environment 100 and adjust the temperature as needed. In some instances, there may be a desired temperature or a desired schedule of temperatures for which the environment 100 should be maintained at. The temperature control system may detect the current temperature of the environment and adjust the temperature accordingly. In some instances, a temperature control system may include internal sensors to detect a temperature. In some instances, one or more sensors, such as sensors 175 or 176, or other sensors within environment 100, can be used to detect the temperature of the environment. In some instances, a heating element external to dehumidifier 110 may be controlled by temperature control system 120 to increase or decrease the horticulture environment temperature. In some instances, temperature control system 120 may be implemented at least in part within dehumidifier 110. For example, an air heater system may be implemented within dehumidifier 110, for example towards the end of the air path within the dehumidifier, and can be used to increase the temperature of the air output by the dehumidifier as needed.

Light control system 130 may control lighting throughout one or more portions of the horticulture environment 100. In some instances, light control system 130 may receive commands from system controller 190 to provide lighting to plants 160 according to a particular schedule. The lighting may include different types of lights, such as sunlight, ultraviolet light, or other light applied to plants 160 within horticulture environment 100.

Watering control system 140 may include a watering system 142 that provides water to plants 160. Watering control system may receive control signals from system controller 180 to provide water to plants 160. In some instances, system controller 180 may include a schedule of watering and may implement the schedule by control signals/commands transmitted to watering control system 140 by system controller 180. In response to receiving control signals, watering control system 140 may water the plants 160 within culture environment 100.

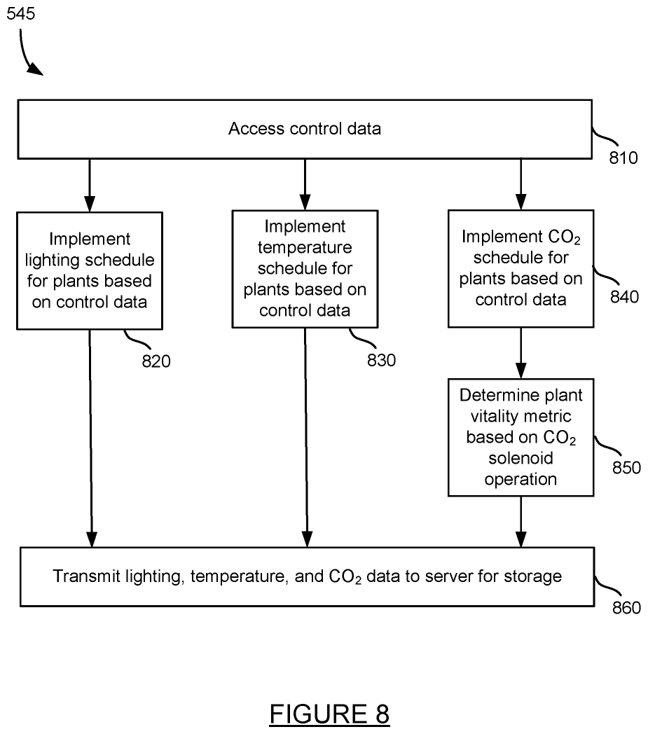

CO₂ control system 150 may control or maintain a level of CO₂ in the environment 100. The CO₂ control system may receive CO₂ commands from system controller 180. In some instances, one or more sensors 171-176 may be used to detect the level of CO₂ in the horticulture environment 100. The sensors may provide the detected CO₂ level data to system controller 180. In response to receiving the CO₂ level data, system controller 180 may generate CO₂ commands and transmit them to CO₂ control system 150, causing the CO₂ control system to release additional CO₂ into horticulture environment 100. The amount of CO₂ released into environment 100 may be tracked, for example as a function of the time that a CO₂ solenoid is opened in order to release CO₂ into the environment 100. This is discussed in more detail with respect to FIG. 8.

Humidity controller 155 may control and maintain the humidity in horticulture environment 100. Humidity controller 155 may receive data related to, for example, environment humidity levels from sensors 171, 172, 173, 174, 175, and 176, and may control the operation of dehumidifier 110 at least in part in response to the received data. In some instances, humidity controller 155 of FIGS. 1A and 1B can be implemented by humidifier controller 255 of the dehumidifier 110 of FIG. 2.

Plants 160 may include any type of flower, fruit, vegetable, tree, or other plant capable of growing within a horticulture environment. In some instances, plants 160 may include cannabis. The horticulture environment may include any environment, including for example a green house, room, or other enclosed space, is that physically closed off such that environmental parameters such as humidity, temperature, CO₂, and watering levels can be controlled.

System controller 180 may also receive data from sensors 171-176. The sensors may include a plurality of types of sensors, including temperature sensors, humidity sensors, light sensors, and CO₂. In some instances, sensors 173 and 174 may be placed along the airflow path extending over plans 160. Sensors 173 may detect features within the airflow such as humidity and CO₂ level, while sensors 174 may detect features in the airflow after air pass through plants 160. As such, a difference in humidity, temperature, and other factors may be determined as the difference in values detected by sensors 173 and 174.

FIG. 1B is a block diagram of another intelligent dehumidifier displaced within a horticulture environment. The horticulture environment of FIG. 1B is similar to that of FIG. 1A, except system controller 180 is implemented externally to dehumidifier 120. System controller 180 of FIG. 1B communicates with sensors 171-176, temperature control system 120, light control system 130, watering control system 140, CO₂ control system 150, and humidity controller 155 in the environment of FIG. 1B.

FIG. 2 is a block diagram of a dehumidifier with a dual coil energy exchanger. The dehumidifier of FIG. 2 provides more detail for the dehumidifier 110 of FIGS. 1A and 1B. The dehumidifier of FIG. 2 includes filter 210, first energy exchange coil 215, dehumidification coil 220, air cleaner 225, air fans 230, second energy exchange coil 235, energy injection/reheat coil 240, and humidity controller 255. Air is received through a dehumidifier input and displaced through filter 210. The filter may remove particulates and then provide the filtered air to first energy exchange coil 215.

First energy exchange coil 215 receives an energy exchange liquid having a cooler temperature than the filtered air. In some instances, the energy exchange liquid temperature may be between 40-60 degrees Fahrenheit. The energy exchange liquid (sometimes referred to as “liquid” herein) can include water or some other liquid capable changing temperature when passed through coils 215 and 235. Though the liquid passing through coils 215 and 235, traveling through the liquid ducts or passageways, may be referred to as water herein for purposes of discuss, such references to the liquid as water are not intended to limit the energy exchange liquid to water.

In some instances, cold water is pumped by variable speed pumping system 245 through liquid throughways 261 and 262. The cold water cools the air that is displaced through filter 210 and provides the cooled air to dehumidification coil 220. As a result of the warmer air passing by the coil of cold water (i.e., the air is warmer than the liquid passing through energy exchange coil 215), the water exiting coil 215 is warmer than the water that entered the coil 215.

Dehumidification coil 220 receives the cool air and dehumidifies the air. Dehumidification coil 220 spends less energy dehumidifying the air because the air has already been cooled towards the dew point from room temperature by first energy exchange coil 215.

Put another way, the passing of horticulture environment air through first energy exchange coil within the dehumidifier reduces the air temperature and changes the temperature of the horticulture environment air closer to, to and maybe even below the air dew point. The reduction of the air temperature (and in some cases humidity) reduces the energy required for the dehumidification coil to bring the temperature of the air completely to the air dew point as compared to the energy that would be required to change the temperature of the horticulture environment air from room temperature to the horticulture environment air dew point, without first reducing the air temperature by the first energy exchange coil.

Dehumidification coil 220 brings the air down to a dew point, whereby water can be withdrawn from the air. The humidified air then goes through air cleaner 225 and is directed by fans 230 to the second energy exchange coil 235.

Second energy exchange coil 235 receives the warm water provided by first energy exchange coil 215. The warm water is pumped or displaced through liquid throughways 263 and 264 from coil 215 to the second coil 235 by variable speed pumping system 250. The warm water received by second coil 235 serves to warm the dehumidified air displaced through coil 235. The cool and dehumidified air passes through the second coil 235, which has warm water running through the coils. The process results in the cooling of the water passing inside coil and exiting coil 235 and a warming of the air passing through the coil. The cool water is then driven by variable speed pumping system 245 back to the first energy exchange coil 215.

The warmed air is provided to energy injection/reheat coil 240. Coil 240 may warm the air to a desired temperature as determined by a system controller 180 and/or temperature controller. The output of the reheat coil is then provided back into the horticulture environment 100.

Humidity controller 255 may receive control commands from system controller 180 to control aspects of the dehumidifier, including but not limited to variable speed pumping systems 245 and 250, air fans 230, dehumidification coil 220, and energy injection/reheat coil 240. Humidity controller 255 may receive control signals from system controller 180 to engage pumping systems 245 and/or 250, turn air fans 230 on or off, and inject energy into the outgoing air by energy injection coil 240.

Though FIG. 2 includes two pumping systems, variable speed pumping system 245 pumping liquid between the second energy exchange coil and the first energy exchange coil and variable speed pumping system 250 pumping liquid between first energy exchange coil and the second energy exchange coil, the dehumidifier 110 of FIG. 2 may operate with only one of systems 245 and 250. Hence, in some instances, the dehumidifier 110 of FIG. 2 can include only one of variable speed pumping system 245 and variable speed pumping system 250, rather than both pumping systems.

By using a dual coil energy exchanger system, the first energy exchange coil 215 and the second energy exchange coil 235 exchange energy to make dehumidification more energy-efficient. The energy efficiency results from a cooling of air received by the dehumidifier when pass through the first energy exchange coil 215. After passing through the first coil and being the humidified, the air is pushed through the second energy exchange coil 235, where the cooled and the humidified air is heated before being output by the dehumidifier. Water is pumped between the first energy exchange coil and the second energy exchange coil so that it can be reuse and the energy within the water is exchanged with the air passing through the dehumidifier.

FIG. 3 is a block diagram of a control architecture for an intelligent dehumidifier. The system of FIG. 3 includes system controller 180, horticulture environments 100, 310, and 320, network 330, sensors 340, server 350, and computing device 360. System controller 180 may communicate with temperature control system 120, light control system 130, watering control system 140, CO₂ control system 150, and humidifier controller 255. In some instances, system controller 180 may control systems in multiple horticulture environments, such as environment 100, environment 310, and environment 320. In this instance, the system controller may be implemented internally to environment 100 or externally to environment 100.

System controller may communicate with computing device 360 via network 330.

Network 330 may include one or more devices that enable machines to communicate with each other. There were 330 may include one or more of the public networks, private networks, intranets, the Internet, a wide area network, a local area network, a cellular network, a Wi-Fi network, or any other network over which data may be communicated.

Computing device 360 may access and communicate with server 350 and system controller 180 through network 330. An administrator 362, through computing device 360, may access control data, environment data, and plant data from application 358 on server 350. The administrator may also program system controller 180 over network 330. The programming of system controller 180 may include temperature, lighting, watering, CO₂, and humidification to implement within an environment 100.

Server 350 may include control data 352, environment data 354, plant data 356, and application 358. The control data may include threshold data and scheduling data used to implement horticulture environment parameters. Examples of control data may include a schedule of temperatures to maintain, a schedule of lighting to implement, plant watering schedules, a level of CO₂ to maintain, and a level of humidity to maintain within the horticulture environment 100. Environment data 354 may include data collected from sensors 340 and other data regarding environment 100, such as for example historic temperature, lighting, humidity and CO₂ data. In some instances, sensors 340 of FIG. 3 may implement sensors 171-176 of the systems of FIGS. 1A and 1B. Plant data may include information regarding the plants contained within a horticulture environment 100, the water consumed by the plants, and so forth. Other data such as account data, login data, and other data may also be stored at server 350 and accessible by application 358.

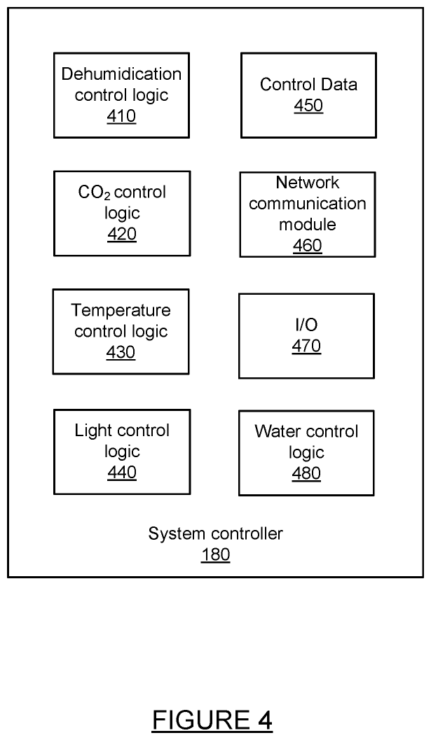

FIG. 4 is a block diagram of a system controller. System controller 180 of FIG. 4 provides more detail for the system controller 180 of FIGS. 1A and 1B. System controller 180 includes dehumidification control logic 410, CO₂ control logic 420, temperature control logic 430, light control logic 440, control data 450, network communication model 460, I/O 470, and water control logic 480.

Dehumidification control logic 410 controls the operation of dehumidifier 110. In some instances, the dehumidification control logic determines when the air should be dehumidified, for example based on sensors within a horticulture environment and a threshold humidity level, and directs humidifier controller 225 to activate a dehumidification process of dehumidifier 110. In some instances, the dehumidification control logic may include thresholds for dehumidification levels that are to be maintained within the horticulture environment.

CO₂ control logic 420 includes logic for controlling a CO₂ control system 150. In some instances, system controller 180 may include CO₂ control logic that maintains a threshold level of CO₂ within the air of a horticulture environment.

Temperature control logic 430 can include logic for maintaining a temperature within a horticulture environment. In some instances, the logic can generate control signals intended to engage a temperature control system 120. In some instances, the control signals may be used to engage an energy injection/reheat coil 240 to heat the air output by the dehumidifier. The control signals for the temperature control system 120 and/or reheat coil 240 may initiate heating of the environment using one or more heating elements suitable for heating air.

Light control logic 440 may include logic for implementing a lighting schedule within the horticulture environment 100. In some instances, light control logic for 40 may control light control system 130 to provide different levels of lighting at different times for plants 160 within the horticulture environment.

Control data 450 may include data such as thresholds for dehumidification, CO₂ level, and temperature. Control data may also include schedules for lighting and watering. The control data may be used by the logic of system controller 182 to control aspects of the horticulture environment.

Network communication module 460 of system controller 180 may be used to communicate with server 350 and/or computing device 360 over network 330.

I/O 470 may be used to receive and process input and generate and process output by system controller 180. For example, I/O 470 may generate a control signal to turn on a light based on a signal, message, or communication received from light control logic for 40.

Water control logic 480 may control watering of plants 160 within horticulture environment 100. The watering may be based on a schedule, detected water use by the plants, and other information.

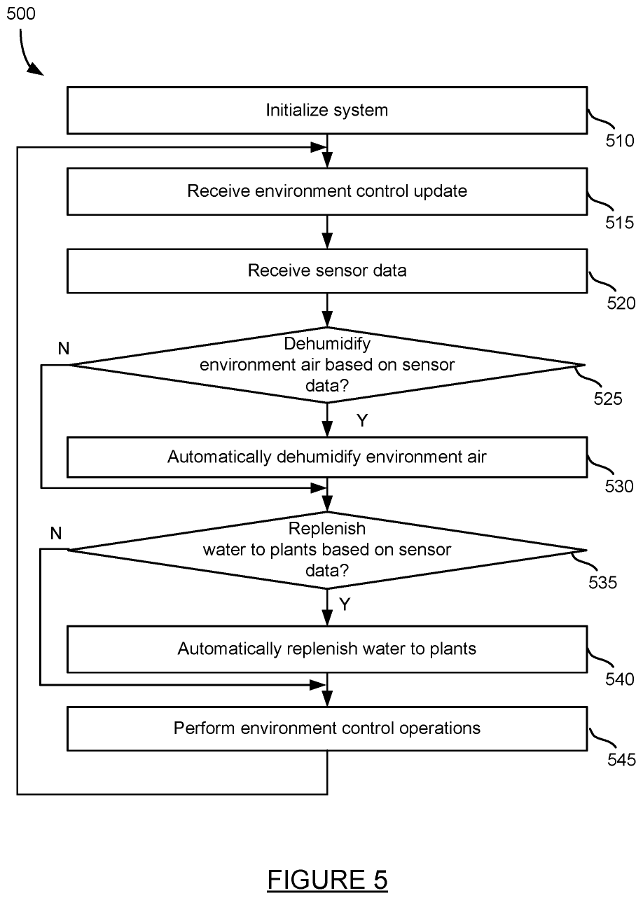

FIG. 5 is an exemplary method for operating an intelligent dehumidifier. It is intended that each of the steps in FIG. 5 is optional, and may be performed in a different order than that listed in FIG. 5. The order and inclusion of each step is presented for purposes of discussion, and is not intended to be limiting.

First, a dehumidifier system is initialized at step 510. Initialization may include establishing connections between a controller and sensors, the system controller and other controllers, powering up fans within a dehumidifier, and other operations. An environment control update may be received at step 515. The environment control update may include updated thresholds or schedules, such as a lighting schedule or temperature threshold, to implement within the environment. In some instances, the update may be received by system controller 180 from server 350 in response to updated threshold data, schedule data, or other changes to data received by server 350 from computing device 360. Sensor data may be received at step 520. In some instances, sensors 171-176 may all provide data to system controller 180 at step 520. In some instances, one or more sensors may provide data to system controller 180 at different times than other sensors. The sensors may push data to system controller periodically, provide the data in response to request, or provide the data based on some other event.

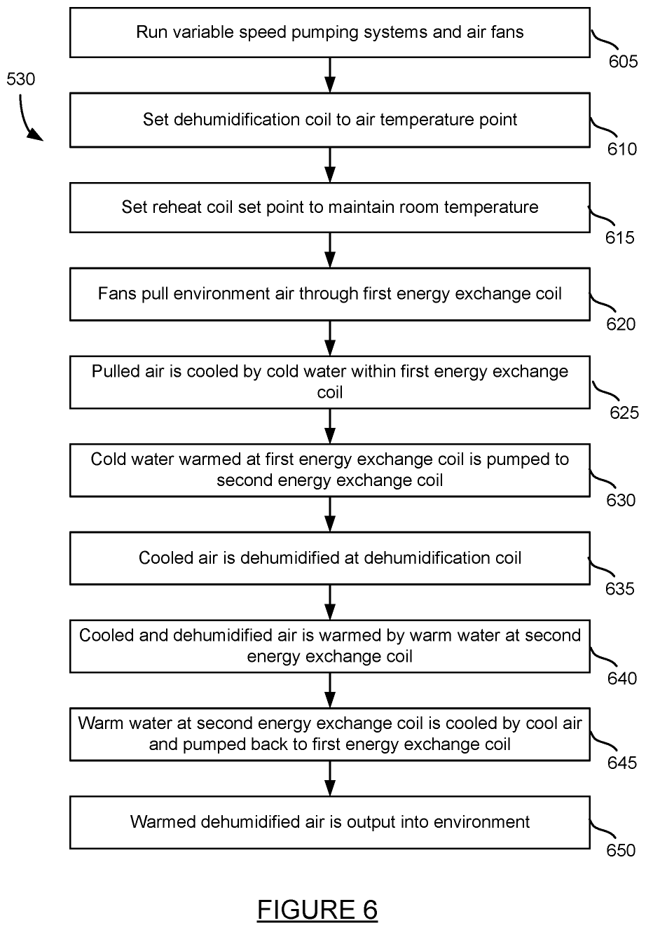

A determination is made as to whether the horticulture environment air should be dehumidified, for example based on sensor data, at step 525. If the detected humidity of the air is greater than a threshold humidity that should be maintained within the horticulture environment, then the environment air is automatically dehumidified at step 530. Dehumidification includes processing air by a dehumidifier with dual coil energy exchangers. More details for automatically dehumidifying horticulture environment air is discussed with respect to the method of FIG. 6. After automatically dehumidifying the air, the method of FIG. 5 continues to step 535. If the air does not need to be dehumidified, the method of FIG. 5 continues to step 535.

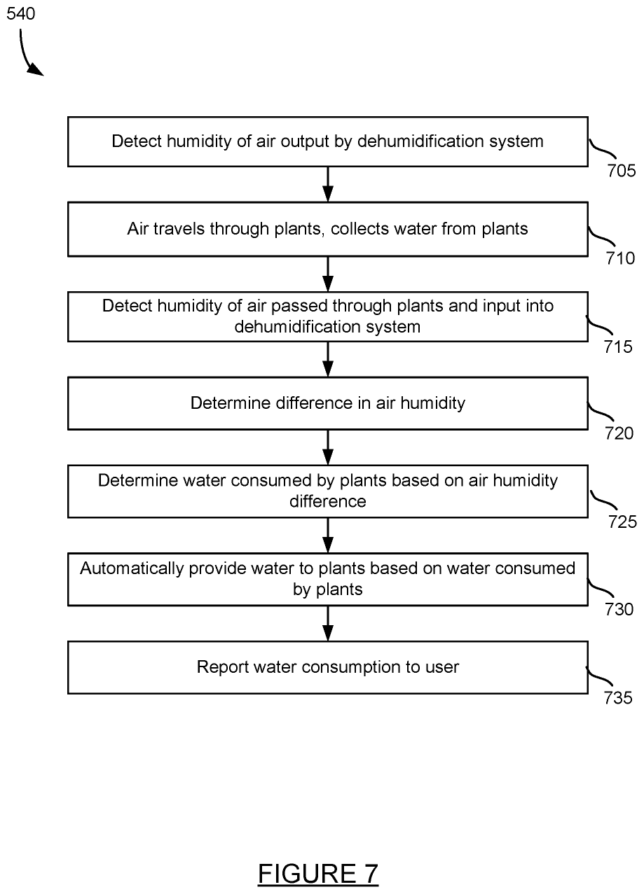

A determination is made as to whether water should be replenished to plants, for example based on sensor data at step 535. In some instances, sensors may detect the water level or humidity level difference between the air leaving the dehumidifier and entering the dehumidifier. Based on this difference in water content within the horticulture environment air, an amount of water being consumed by the plants can be determined. If no water is to be replenished at step 535, the method of FIG. 5 continues to step 545. If water is to be replenished to the plants based on sensor data at step 535, water is automatically replenished to the plants at step 540. More detail for automatically replenishing water the plants is discussed with respect to the method of FIG. 7.

Other environment control operations are performed at step 545. The additional environment control operations may include maintaining the temperature of the environment, the lighting of the environment, and the CO₂ level the environment. More details for performing environment control operations are discussed with respect to the method of FIG. 8.

FIG. 6 is an exemplary method for automatically dehumidifying air in a horticulture environment. The method of FIG. 6 provides more detail for step 530 of the method of FIG. 5. First, variable speed pumping systems and air fans may be run at step 605. The variable speed pumping systems may circulate liquid, such as for example water, between the energy exchange coils and the air fans may drive air through the dehumidification system. A dehumidification coil is set to an air temperature point at step 610. The temperature point may be a point at which water can be removed from the air, such as the air dew point. Optionally, a reheat coil is set to a point at which to maintain a room temperature at step 615.

One or more air fans may then pull environment air through a first energy exchange coil at step 620. The pulled air is then cooled by cold liquid (such as water, traveling inside the coils, that has a temperature that is cooler than the air traveling through the coils) within the first energy exchange coil at step 625. Once the liquid has traveled through the first coil, the liquid temperature is increased and is pumped to the second energy exchange coil at step 630. The cold air is dehumidified at a dehumidification coil at step 635. The cooled air may be dehumidified by bringing the air temperature below a dewpoint for the air. The cooled and the dehumidified air is warmed by warmed liquid traveling inside a second energy exchange coil at step 640. The warm liquid at the second energy exchange coil is cooled by cool air traveling through the second energy exchange coil and is pumped back to the first energy exchange coil at step 645. The warmed and dehumidified air may optionally be warmed by an energy insertion coil within the dehumidifier. The dehumidified air is then output into the environment at step 650.

FIG. 7 is an exemplary method for automatically replenishing water in a horticulture environment. The method of FIG. 7 provides more detail for step 540 the method of FIG. 5. First, the humidity of the horticulture environment air is detected at the output of the dehumidification system at step 705. The air may then travel through plants and collect water from the plants at step 710. The water collected from the plants by the circulating air is a direct indication of the water usage by the plants. The humidity of the air passed through the plants and input into the dehumidification system is detected at step 715. A difference in air humidity between the air output by the dehumidification system and the air input by the dehumidification system is determined at step 720. The water consumed by the plants is then determined based on the air humidity difference at step 725. Water can then automatically be provided to the plants based on the water consumed by the plants at step 730. In some instances, the water provided to the plants can be determined as the difference in humidity plus an additional amount of water. The water consumption of the plants is then recorded at server 350 and reported to a user at step 735.

FIG. 8 is an exemplary method for performing environment control operations in a horticulture environment. The method of FIG. 8 provides more detail for step 545 of the method of FIG. 5. Control data may be accessed at step 810. Control data 352 may be accessed from server 350 by system controller 180 and stored locally as control data 450 within system controller 180. Control data, which can include data such as a lighting schedule, temperature schedule or threshold, and CO₂ schedule or threshold data, is retrieved and utilized to control aspects of the horticulture environment 100. At step 820, a lighting schedule is implemented for plants based on lighting control data. The temperature schedule is implemented for plants based on temperature control data at step 830.

A CO₂ schedule is implemented for plants based on CO₂ control data at step 840. In some instances, after implementing the CO₂ schedule, a plant vitality metric based on the CO₂ solenoid operation may be determined at step 850. The plant vitality metric may be based at least in part on the amount of CO₂ released into the environment. The amount of CO₂ released into the environment may be determined at least in part, for example, by an amount of time that a solenoid is kept open while CO₂ is released from the solenoid. Lighting temperature and CO₂ data are then detected by sensors 171-176 within environment 100 and transmitted to server 350 for storage and reporting to user.

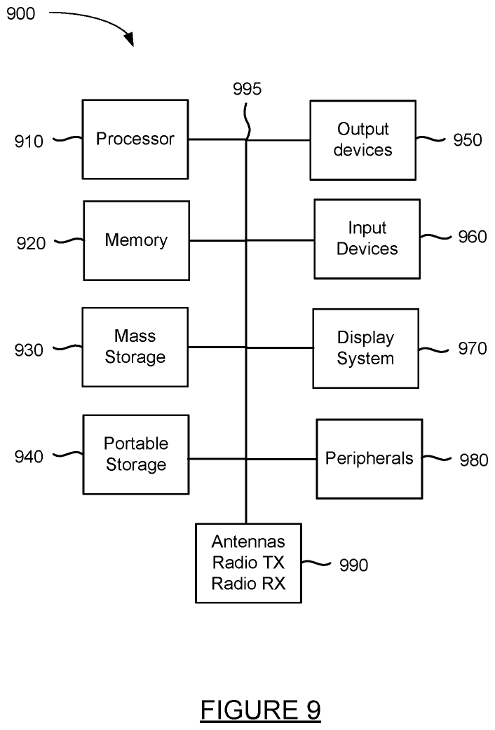

FIG. 9 is a block diagram of a computing environment for implementing the present technology. System 900 of FIG. 9 may be implemented in the contexts of the likes of computing devices that implement system controller 180, control systems 120, 130, 140, and 150, controller 255, server 350, and computing device 360. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive, an optical disk drive, a flash drive, or other device, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, such as a floppy disk, compact disk or Digital video disc, USB drive, memory card or stick, or other portable or removable memory, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information and processes the information for output to the display device. Display system 970 may also receive input as a touch-screen.

Peripherals 980 may include any type of computer support device to add additional functionality to the computer system. For example, peripheral device(s) 980 may include a modem or a router, printer, and other device.

The system of 900 may also include, in some implementations, antennas, radio transmitters and radio receivers 990. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A system for automatically dehumidifying a horticulture environment, comprising:
a dehumidifier that dehumidifies air that flows from a dehumidifier input towards a dehumidifier output within the dehumidifier, the air flow traveling through plants within a horticulture environment while outside the dehumidifier, the dehumidifier including:
a dehumidification mechanism,
a first energy exchange coil, positioned upstream in the air flow within the dehumidifier, and
a second energy exchange coil positioned downstream in the air flow within the dehumidifier, wherein an energy exchanging liquid moves from the second energy exchange coil to the first energy exchange coil along a first path, and the energy exchange liquid moving from the first energy exchange coil to the second energy exchange liquid along a second path,
the energy exchange liquid being warmed when traveling through the first energy exchange coil and traveling to the second energy exchange coil as a cool energy exchange liquid,
the energy exchange liquid being cooled when traveling through the second energy exchange coil and traveling to the first energy exchange coil as a warm energy exchange liquid;
a plurality of sensors, wherein the sensors detect humidity in a plurality of positions within the horticulture environment and outside the dehumidifier;
a system controller that receives data from the plurality of sensors, the system controller sending control signals to the dehumidifier based on the data received from the plurality of sensors,
the dehumidifier performing dehumidification of the horticulture environment air in response to control signals received from the system controller.

2. The system of claim 1, further comprising a watering system including:
a watering system controller; and
a watering mechanism in communication with the watering system controller and configured to provide water to the horticulture environment plants,
the system controller providing watering control signals to the watering system controller to provide water to at least a portion of the horticulture environment plants, the watering control signal generated in response to detecting the amount of water that the horticulture environment plants have consumed over a period of time.

3. The system of claim 2, Wherein the amount of water that the horticulture environment plants have consumed over a period of time is determined from a change in humidity level within the horticulture environment detected at the output of the dehumidifier and the input of the dehumidifier.

4. The system of claim 1, further comprising a carbon dioxide monitoring system including:
a carbon dioxide controller; and
a carbon dioxide release mechanism in communication with the carbon dioxide controller and configured to release carbon dioxide into the horticulture environment,
the system controller providing carbon dioxide control signals to the carbon dioxide controller to release carbon dioxide into the horticulture environment, the carbon dioxide control signal generated in response to detecting the amount of carbon dioxide in the horticulture environment.

5. The system of claim 4, wherein the quantity of carbon dioxide released into the horticulture environment is tracked and reported to the system controller, and the quantity of carbon dioxide released into the horticulture environment received by the system controller is reported to a user.

6. The system of claim 1, wherein the system controller can communicate with a remote server application implemented at server remote from the system controller, the system controller receiving control data from the server application, the system controller transmitting environment data captured by one or more sensors to the server application.

7. The system of claim 1, wherein the system controller is programmed with one or more schedules of environmental parameters to implement within the horticulture environment.

8. The system of claim 7, wherein the one or more schedules includes a lighting schedule and a temperature schedule,
the lighting schedule implemented by transmitting one or more lighting control commands to a lighting system within the horticulture environment by the system controller,
the temperature schedule implemented by transmitting one or more temperature control commands to a temperature system within the horticulture environment by the system controller

8. The system of claim 1, wherein the passing of horticulture environment air through first energy exchange coil within the dehumidifier reduces the air temperature and changes the temperature of the horticulture environment air closer to the air dew point, the reduction of the air temperature thereby reducing the energy required for the dehumidification coil to bring the temperature of the air completely to the air dew point as compared to the energy required to change the temperature the horticulture environment air from room temperature to the horticulture environment air dew point without first reducing the air temperature by the first energy exchange coil.

9. The system of claim 1, wherein the dehumidification system includes a dehumidification coil.

10. The system of claim 1, wherein the system controller is external to and in communication with the dehumidifier.

11. A method for automatically dehumidifying a horticulture environment
receiving air from a horticulture environment by a dehumidifier;
displacing the received air through a first energy exchange coil, the first energy exchange coil receiving energy exchange liquid that is colder than the received air, the temperature of the air being lowered as a result of being passed through the first energy exchange coil, the temperature of the energy exchange liquid being increased as a result of passing warm air through the first energy exchange coil;
dehumidifying the cooled air by a dehumidifier;
displacing the warmed energy exchange liquid to a second energy exchange coil;
displacing the dehumidified air through a second energy exchange coil, the second energy exchange coil receiving the energy exchange liquid from the first energy exchange coil, the energy exchange liquid received by the second energy exchange coil being warmer than the dehumidified air, the temperature of the air being increased as a result of being passed through the second energy exchange coil, the temperature of the energy exchange liquid being decreased as a result of passing the dehumidified air through the second energy exchange coil;
outputting the dehumidified air to the horticulture environment after the air is displaced through the second energy exchange coil;
receiving data from a plurality of sensors;
repeating the steps of receiving air, displacing the received air through a first energy exchange coil, dehumidifying the cooled air, displacing the dehumidified air through a second energy exchange coil, and outputting the dehumidified air in response to the data received from the plurality of sensors.

12. The method of claim 11, the method further comprising:
detecting a difference in water content within the dehumidified air external to the dehumidifier, the difference detected by humidity data captured by at least two of the plurality of sensors displaced in the horticulture environment; and
sending a control signal to a watering system to provide a quantity of water to plants in the horticulture environment, the quantity of water determined based at least in part on the difference in water content.

13. The method of claim 11, the method further comprising:
detecting a level of carbon dioxide in the horticulture environment, the level of carbon dioxide detected by at least one of the plurality of sensors;
injecting a quantity of carbon dioxide into the horticulture environment, the quantity based on a threshold of carbon dioxide associated with the horticulture environment and the detected level of carbon dioxide; and
reporting the quantity of the infected carbon dioxide to a user.

14. The method of claim 12, the method further comprising;
receiving, by a system controller in communication with the dehumidifier, one or more schedules of environmental parameters to implement within the horticulture environment; and
generating control commands to one or more additional controllers to implement the thresholds within the horticulture environment

15. The method of claim 14, wherein generating control signals includes:
generating and transmitting one or more lighting control commands to a lighting system, by the system controller within the horticulture environment, to implement a schedule of lighting for plants within the horticulture environment; and
generating and transmitting one or more temperature control commands to a temperature system, by the system controller within the horticulture environment, to implement a schedule of temperatures for plants within the horticulture environment.

16. The method of claim 11, wherein displacing air through first energy exchange coil within the dehumidifier reduces the air temperature and changes the temperature of the horticulture environment air closer to the air dew point, the reduction of the air temperature thereby reducing the energy required for the dehumidification coil to bring the temperature of the air completely to the air dew point as compared to the energy required to change the temperature the horticulture environment air from room temperature to the horticulture environment air dew point without first reducing the air temperature by the first energy exchange coil.

17. The method of claim 11, wherein the system controller is external to and in communication with the dehumidifier.
